(19) United States
(12) Patent Application Publication
(10) Pub. No.: US 2016/0149991 A1
(43) Pub. Date: May 26, 2016

(54) BULK UPLOAD OF COLLABORATIVE DOCUMENTS TO AN ONLINE DOCUMENT MANAGEMENT SYSTEM

(71) Applicant: Ricoh Americas Holdings, West Caldwell, NJ (US)

(72) Inventor: Christopher Ables, Coral Springs, FL (US)

(73) Assignee: RICOH COMPANY, LTD., Tokyo (JP)

(21) Appl. No.: 14/548,688

(22) Filed: Nov. 20, 2014

(51) Int. Cl. H04L 29/08; G06F 17/30

(52) U.S. Cl. CPC H04L 67/06; G06F 17/30076; G06F 17/30073

(57) ABSTRACT

Embodiments describe bulk upload capabilities from a computing device to an online document management system utilizing a batch file. In one embodiment, a computing device identifies a local folder and a batch file in the local folder that defines a plurality of files to upload to the management system. The computing device parses the batch file to identify a local file in the local folder, and parses the batch file to identify a remote folder at the management system for storing a remote copy of the local file. The computing device parses the batch file to identify metadata assigned to the local file, transmits a first Remote Procedure Call (RPC) request to the management system to upload the local file to the remote folder, and transmits a second RPC request to the management system to assign the metadata to the remote copy of the local file.

### FIELD OF THE INVENTION

The invention relates to the field of online document management systems, and in particular, to bulk upload activities of documents to an online document management system.

### BACKGROUND

An online document management system allows users to store, access, and manage their documents remotely in the cloud. In addition to basic storage and retrieval services, the document management system may provide additional services to users such as the creation of custom document types, the assignment of metadata for documents, indexing of documents, Optical Character Recognition (OCR) services for documents, version control for documents, etc.

A client computer will typically utilize a replication service to upload files from a local folder on the client computer to a remote folder on the document management system. This process may occur periodically (e.g., once per hour). However, this process is typically limited in flexibility when attempting to upload a large number of files to the document management system. For instance, it may be desirable that the files be distributed across a number of different remote folders at the document management system and/or have different assigned security levels, assigned custom metadata (document author, document type, document date, document project, etc.).

### SUMMARY

Embodiments described herein provide bulk upload capabilities from a computing device to an online document management system utilizing a batch file. The batch file includes various criteria for the upload process, such as information about files that are included in the upload process, a location at the document management system for the files, and metadata (e.g., document type information, permissions, etc.) assigned to the files. Utilizing the batch file, a computing device (e.g., a computer) can quickly and efficiently transfer large numbers of files to the document management system, while providing significant flexibility where the files are located on the document management system and what metadata is assigned to the files.

In one embodiment, a processor of a computing device is configured to identify a local folder of the computing device, and to identify a batch file in the local folder that defines a plurality of files to upload from the local folder to an online document management system. The processor is further configured to parse the batch file to identify a local file in the local folder, to parse the batch file to identify a remote folder at the document management system for storing a remote copy of the local file, and to parse the batch file to identify metadata assigned to the local file. The processor is further configured to transmit a first Remote Procedure Call (RPC) request to the document management system to upload the local file to the remote folder, and to transmit a second RPC request to the document management system to assign the metadata to the remote copy of the local file.

Another embodiment is a method for bulk uploading of local files from a computing device to an online document management system utilizing a batch file. The method comprises identifying a local folder of the computing device, and identifying a batch file in the local folder that defines a plurality of files to upload from the local folder to the document management system. The method further comprises parsing the batch file to identify a local file in the local folder, and parsing the batch file to identify a remote folder at the document management system for storing a remote copy of the local file. The method further comprises parsing the batch file to identify metadata assigned to the local file, transmitting a first RPC request to the document management system to upload the local file to the remote folder, and transmitting a second RPC request to the document management system to assign the metadata to the remote copy of the local file.

Another embodiment is a non-transitory computer readable medium embodying programmed instructions which, when executed by a processor of a computing device, direct the processor to identify a local folder of the computing device, and to identify a batch file in the local folder that defines a plurality of files to upload from the local folder to an online document management system. The instructions further direct the processor to parse the batch file to identify a local file in the local folder, and to parse the batch file to identify a remote folder at the document management system for storing a remote copy of the local file. The instructions further direct the processor to parse the batch file to identify metadata assigned to the local file, and to transmit a first RPC request to the document management system to upload the local file to the remote folder. The instructions further direct the processor to transmit a second RPC request to the document management system to assign the metadata to the remote copy of the local file.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a document collaboration system in an exemplary embodiment.

FIG. 2 is a block diagram of the computing device of FIG. 1 in an exemplary embodiment.

FIG. 3 is a flowchart illustrating a method for bulk uploading of local files from a computing device to an online document management system utilizing a batch file in an exemplary embodiment.

FIG. 4 is a block diagram of another document collaboration system in an exemplary embodiment.

FIGS. 5A and 5B illustrate an XML schema for batch files in an exemplary embodiment.

FIG. 6 is a block diagram of a processing system configured to execute programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

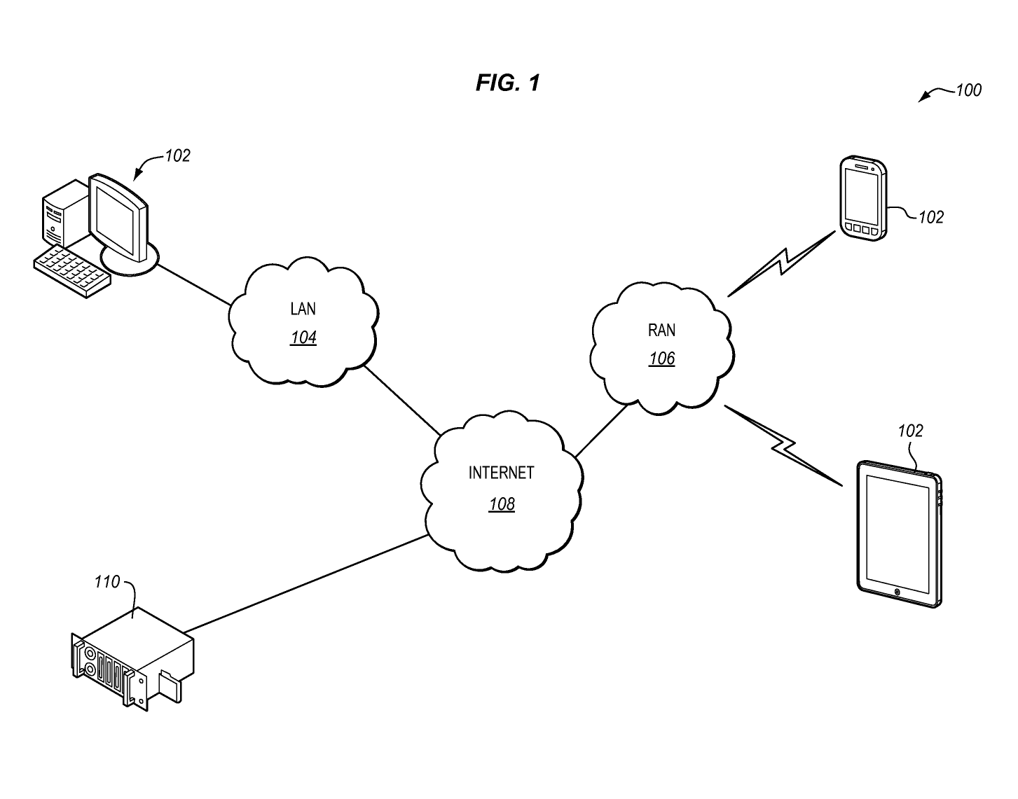

FIG. 1 is a block diagram of a document collaboration system 100 in an exemplary embodiment. In this embodiment, system 100 includes an online document management system 110, which is coupled to the Internet 108 to allow computing devices 102 to participate in a collaborative document environment. In this embodiment, document management system 110 includes any component, system, or device that is able to remotely store and manage documents for computing devices 102. For example, document management system 110 may include one or more file servers that allow computing devices 102 to upload files to document management system 110, download files from document management system 110, check out files, lock files, etc. Document management system 110 may also be referred to as a cloud storage system or an online file management system and/or service.

In this embodiment, three computing devices 102 are illustrated, although the implementation of system 100 may include more or fewer computing devices 102 as an implementation choice. Also, system 100 is not necessarily limited to the particular computing devices 102 illustrated in FIG. 1. In FIG. 1, one of computing devices 102 comprises a computer, which is coupled to Internet 108 utilizing a Local Area Network (LAN) 104. One example of LAN 104 is Ethernet. Also in FIG, 1, another of computing devices 102 comprises a smartphone, which is coupled to Internet 108 using a Radio Access Network (RAN) 106. Some examples of RAN 106 include Wi-Fi networks, cellular networks such as a Global System for Mobile Communications (GSM) network, a Code Division Multiple Access (CDMA) network, etc. RAN 106 may be coupled with additional network elements to interface with Internet 108 (e.g., core network elements), not shown. Another one of computing devices 102 comprises a tablet computer, which also couples to Internet 108 using RAN 106.

In this embodiment, computing devices 102 comprise any component, system, or device that are able to bulk upload local files to document management system 110 utilizing a batch file. For example, computing device 102 may process a batch file to identify files in a local, identify remote folders at document management system 110 for the files and identify various pieces of metadata for the files. During an upload process, the files are distributed to various remote folders at document management system 110 based the information in the batch file, and the metadata identified in the batch file for the local files is assigned to the uploaded files. Utilizing a batch file, computing devices 102 are able to quickly and efficiently upload a number of files in bulk to document management system 110 with little or no user interaction.

The bulk upload process may occur automatically based on a schedule, may occur in response to the user saving files to a particular folder, may occur in response to a scan operation performed by a user, etc. For instance, a user may create a scan project for a number of documents, generating scan data and a batch file for the scan data in the process. If a local folder of computing device 102 is a scan destination for the scan job, then computing device 102 may automatically trigger a bulk upload process for files in response to detecting files and/or the batch file in the local folder. This allows the user to upload a large number of documents to document management system 110 substantially automatically.

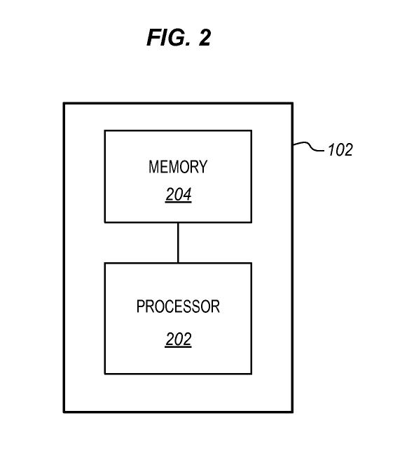

FIG. 2 is a block diagram of computing devices 102 of FIG. 1 in an exemplary embodiment. In this embodiment, computing devices 102 include a processor 202 and a memory 204. Processor 202 includes any hardware device that is able to perform functions. Processor 202 may include one or more Central Processing Units (CPU), microprocessors, Digital Signal Processors (DSPs), Application-specific Integrated Circuits (ASICs), etc. Some examples of processors include Intel® Core™ processors, Advanced Risk Machines (ARM®) processors, etc.

Memory 204 includes any hardware device that is able to store data. For instance, memory 204 may store local files for upload to document management system 110, may store one or more batch files, etc. Memory 206 may include one or more volatile or non-volatile Dynamic Random Access Memory (DRAM) devices, FLASH devices, volatile or non-volatile Static RAM devices, hard drives, Solid State Disks (SSDs), etc. Some examples of non-volatile DRAM and SRAM include battery-backed DRAM and battery-backed SRAM.

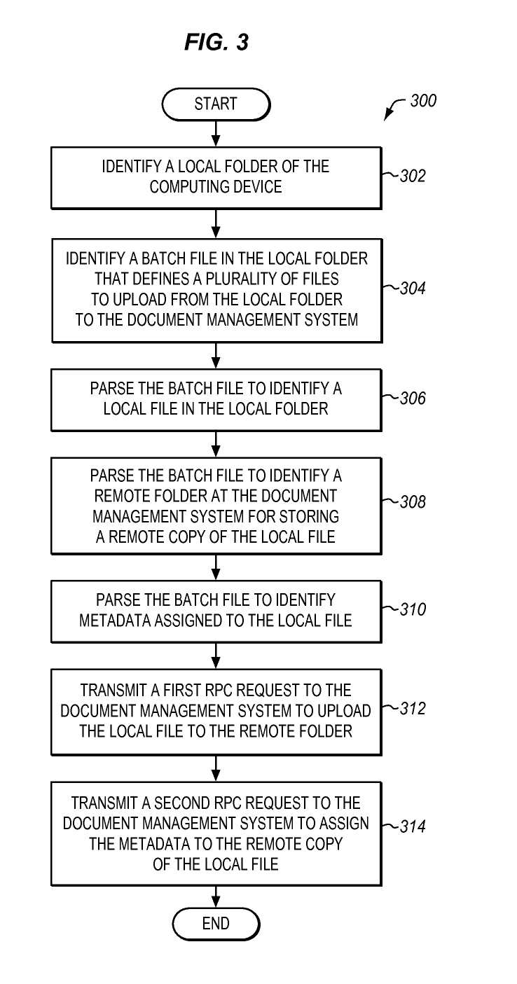

For this embodiment, assume that computing device 102 has access to document management system 110. Also assume that one or more local files exits in a local folder at computing device 102, and that a batch file is present in the local folder that defines files to upload to document management system 110. A bulk upload process may then begin at computing device 102. For instance, a user may manually initiate the bulk upload process, computing device 102 may automatically initiate the bulk upload process (e.g., in response to a schedule, in response to identifying a batch file in the local folder, etc.) FIG. 3 is a flowchart illustrating a method of bulk uploading local files from a computing device to an online document management system utilizing a batch file in an exemplary embodiment. The steps of method 300 will be described with reference to FIGS. 1-2, but those skilled in the art will appreciate that method 300 may be performed in other systems. The steps of the flowchart(s) described herein are not all inclusive and may include other steps not shown. The steps described herein may also be performed in an alternative order.

Processor 202 identifies a local folder of computing device 102 (see step 302 of FIG. 3). The local folder may be identified based on a pre-defined configuration that informs computing device 102 that a particular local folder on computing device 102 will be used for bulk uploads to document management system 110. For instance, a user may have previously selected a local folder on computing device 102 as an upload folder for the bulk upload process.

Processor 202 identifies a batch file in the local folder that defines a plurality of files to upload to document management system 110 (see step 304). The batch file may have a specialized file type, file name, etc., which can be used by processor 202 to differentiate between batch files and files in the local folder that will be uploaded to document management system 110. In some embodiments, the batch file is created automatically during a scan job for documents. For example, a user may approach a scanner, and enter information for the scan project that includes which remote folders on document management system 110 that the documents will be uploaded to, author information, permissions for the documents, a scan destination for the project (e.g., an upload folder on computing device 102), etc. In performing the scan project, the scanner generates electronic files for the scanned documents, generates a batch file for the project, and transmits the batch file and the electronic files to the local folder on computing device 102.

Processor 202 parses the batch file to identify a local file in the local folder (see step 306). The batch file may specify one or more local files for upload in a number of different ways. For example, the batch file may be an Extensible Markup Language (XML) file that uses a pre-defined XML schema that specifies the format and location within the batch file for defining information about files to upload to document management system 110. The batch file may specify the local file using a file name, a Globally Unique IDentifier (GUID), etc. In some embodiments, processor 202 may pre-process the batch file during the parsing stage to determine if the batch file has errors. For example, processor 202 may analyze the batch file to determine if tags are missing (e.g., the batch file does not identify any files to upload), if information is missing (e.g., the batch file does not identify any remote folders for the local files), and/or if the format of the batch file is incorrect. If errors exist in the batch file, then processor 202 may halt parsing of the batch file and present the errors to a user for correction.

Processor 202 parses the batch file to identify a remote folder at document management system 110 for storing a remote copy of the local file (see step 308). To do so, processor 202 may identify tags or other data structures in the batch file that define a remote folder for the local file. For example, the batch file may include XML tags which define a local folder that will store a remote copy of the local file.

Processor 202 parses the batch file to identify metadata assigned to the local file (see step 310). If the batch file is an XML file, then processor 202 may identify various XML tags in the batch file that are defined for the local file. Some examples of metadata for a local file include an author of the local file, a project associated with the local file, permissions for accessing the local file upon upload (e.g., which users of document management system 110 have access to the remote copy of the local file, whether the access is read/write, read only, etc.).

Processor 202 transmits an RPC request to document management system 110 to upload the local file to the remote folder identified in step 308 (see step 312). The RPC request to upload the local file to the document management system 110 may be performed using an Application Programming Interface (API) request to document management system 110. For example, computing device 102 may generate a Hyper Text Transfer Protocol (HTTP) API request or a HTTP Secure (HTTPS) API request for document management system 110. The API request may include various parameters such as the name of the local file to upload, path information at document management system 110, etc. If the remote folder does not exist at document management system 110, then processor 202 may create the remote folder (e.g., using an API request to document management system 110) prior to uploading the local file.

Processor 202 transmits an RPC request to document management system 110 to assign the metadata identified in step 310 to the remote copy of the local file (see step 314). The RPC request for assigning the metadata to the remote copy at document management system 110 may be performed using an API request to document management system 110. For example, computing device 102 may generate a HTTP API request or a HTTPS API request for document management system 110 that instructs document management system 110 to assign the metadata to the remote copy of the local file. The API request to assign the metadata may include various parameters such as the document type of the remote copy, the name of the remote copy, an owner or user (e.g., a user of document management system 110) of the remote copy, permissions for the remote copy, title information, subject information, keywords, authors, etc., for the remote copy.

In response to uploading the local file and assigning the metadata, processor 202 may parse the batch file (e.g., either sequentially or initially during a pre-parsing phase) to identify additional local files to upload, if any, and perform steps 306-314 repetitively until all of the files identified in the batch file have been processed. If errors are encountered during the performance of steps 306-314, then processor 202 may log the errors to allow a user to make corrections.

In some embodiments, the local files may be archived subsequent to the bulk upload process. Processor 202 may move the local files after the bulk upload process to an archive folder on computing device 102. If errors are encountered for a particular file, then processor 202 may move the file to a particular folder (e.g., an error folder), which allows the user to identify which local files, if any, failed to upload to document management system 110.

In some embodiments, a local file may be associated with a rendition file, which also may be uploaded as part of the batch upload process for the local file. A rendition file is based on the local file, but has a different format than the local file. For example, if the local file is a Portable Document Format (PDF) file, then the rendition file may be an image file version of the PDF file (e.g., a Joint Photographic Experts Group (JPEG) version, a Tagged Image File Format (TIFF) version, etc.), a text copy of the PDF file (e.g., the result of an Optical Character Recognition (OCR) process, etc.). To upload a rendition file to document management system 110, processor 202 may generate an API request for document management system 110 that includes information that associates the remote copy of the local file with the rendition file.

Utilizing batch files, computing devices 102 are able to quickly and efficiently upload numerous files to document management system 110, allowing the uploaded files to be distributed across multiple remote folders, and allowing for metadata assignments to occur with little or no interaction from a user. Further, any errors encountered during the batch upload process can be readily identified from log files, based on local files in error folders, etc., which allows a user to make whatever changes are necessary to resume or restart the batch upload process.

### EXAMPLE

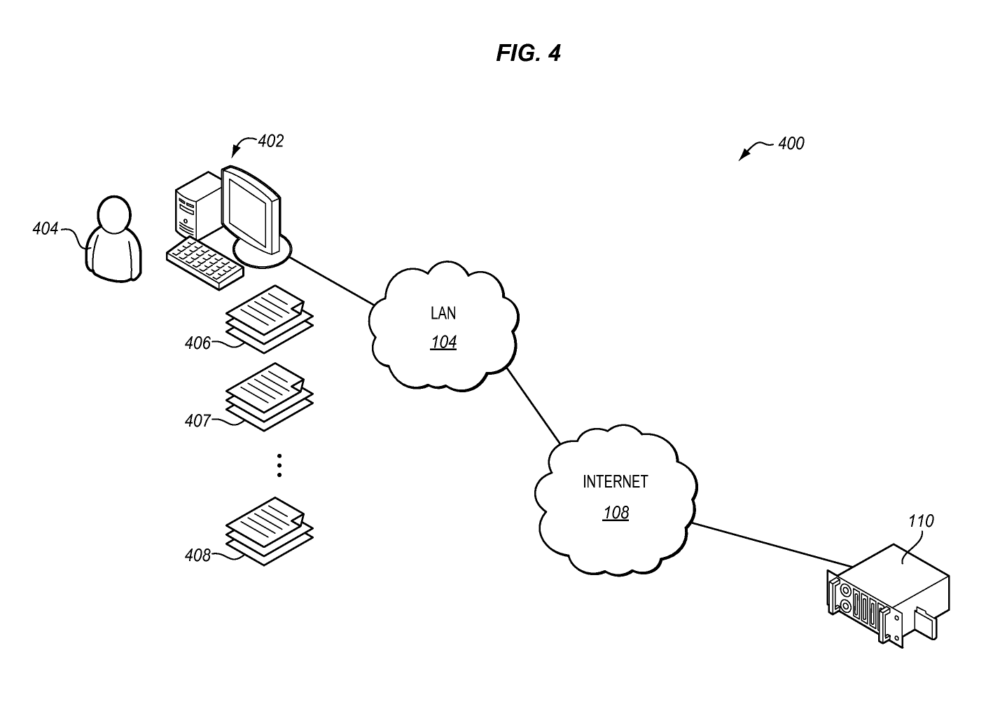

The following example will be discussed with respect to online collaboration system 400 of FIG. 4. The example is not intended to define a preferred embodiment or limit the scope of the claims but rather, is intended to provide one possible implementation of synchronizing documents between a computing device and an online document management system.

Assume for this embodiment that user 404 approaches a computer 402 and launches a batch upload agent. The batch upload agent determines that a plurality of documents 406-408 are located in a local folder of computer 402, which has been defined by user 404 as an upload folder for the batch upload agent. User 404 may, for instance, have previously configured the batch upload agent to look for files to upload and a corresponding batch file in the local folder of computer 402.

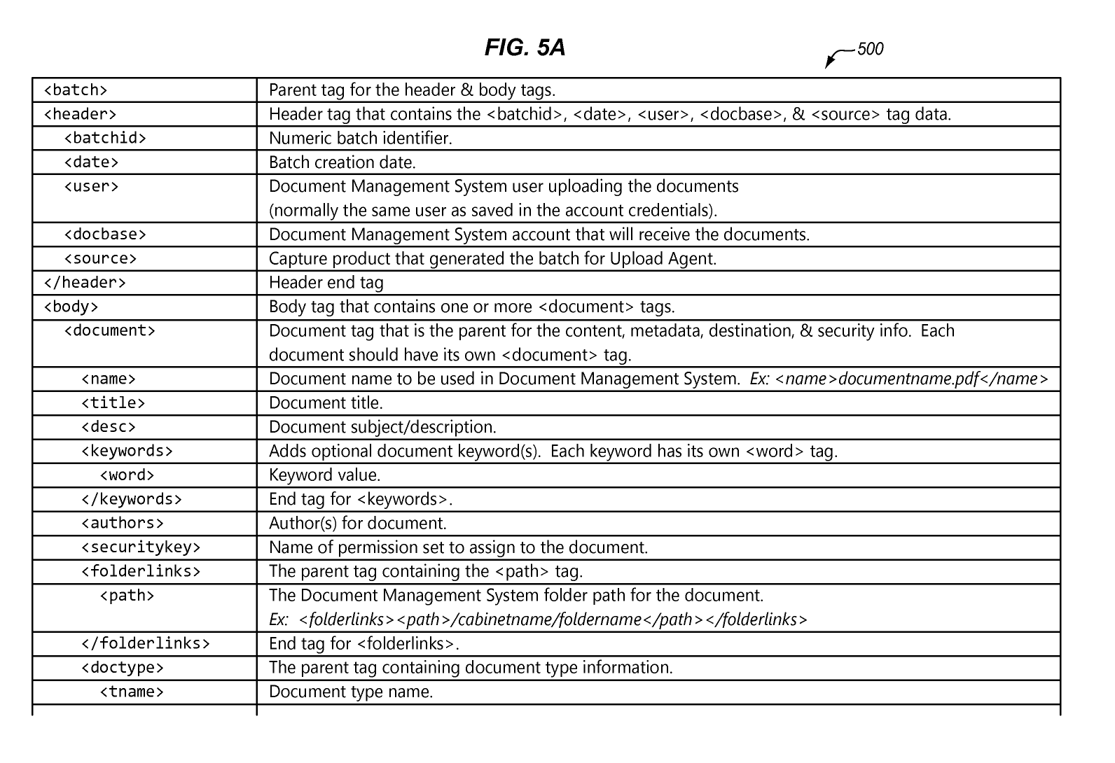

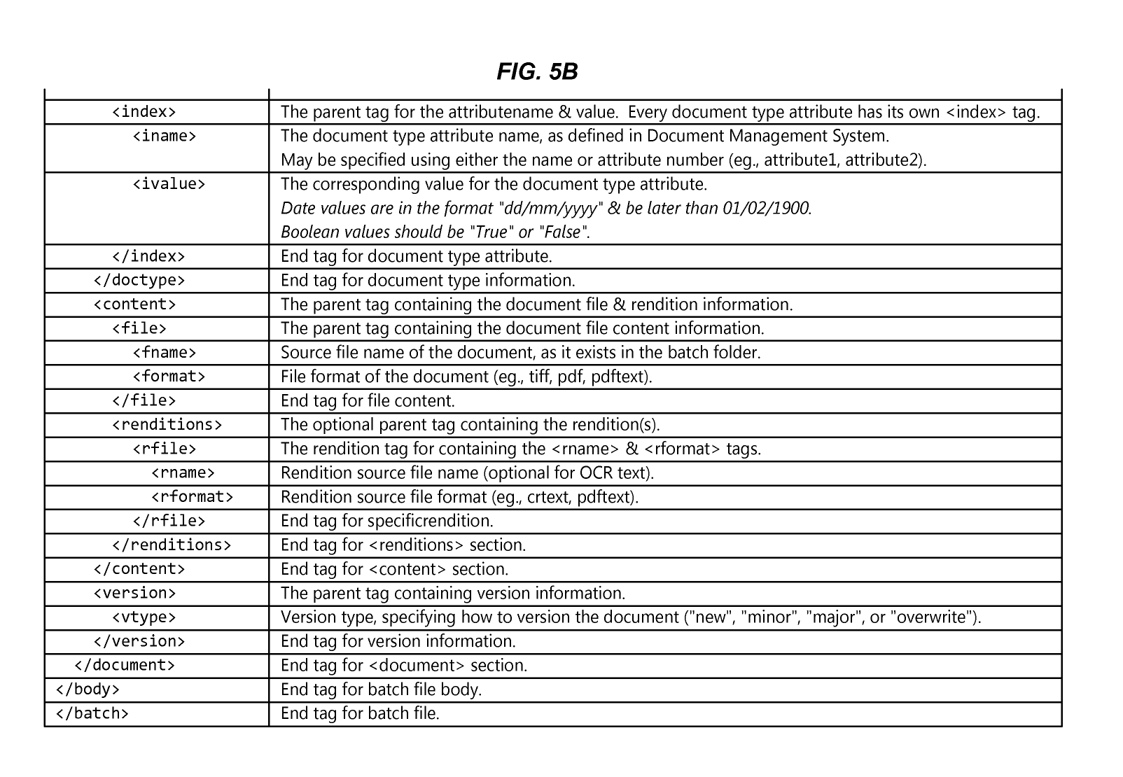

The batch upload agent analyzes the local folder, locates a batch file in the local folder, and begins parsing the batch file. In the example, the batch file is an XML file that is based on an XML schema for bulk uploading local files from computer 402 to document management system 110. FIGS. 5A and 5B illustrate an XML schema 500 for batch files in an exemplary embodiment. Schema 500 includes a variety of nested XML fields that can be identified by the batch upload agent in the batch file. For instance, the upload agent may identify a local file to upload based on the <fname> XML tags in the batch file (e.g., the batch file may identify “bob.doc” in the batch file as <fname> bob.doc</fname>). The upload agent may identify a remote folder for the local file at document management system 110 based on the <path> XML tags in the batch file, which would be nested under the entry for “bob.doc” (e.g., the batch file may identify the remote folder for the local file as <path>/finance project</path>). Further, the upload agent may identify various pieces of metadata for “bob.doc”, such as the document title (e.g., the <title> XML tag), the document subject/description (e.g., the <desc> XML tag), keywords (e.g., the <keywords> XML tag), authors (e.g., the <authors> XML tag), permissions (e.g., the <securitykey> XML tag), a file format (e.g., the <format> XML tag), rendition files, if any (e.g., the <rname> XML tag), etc. Computer 402 is able to generate a number of API requests to document management system 110 to both upload local documents 406-408 identified in the batch file, and to assign the metadata associated with local documents 406-408 identified in the batch file to the remote copies located at document management system 110.

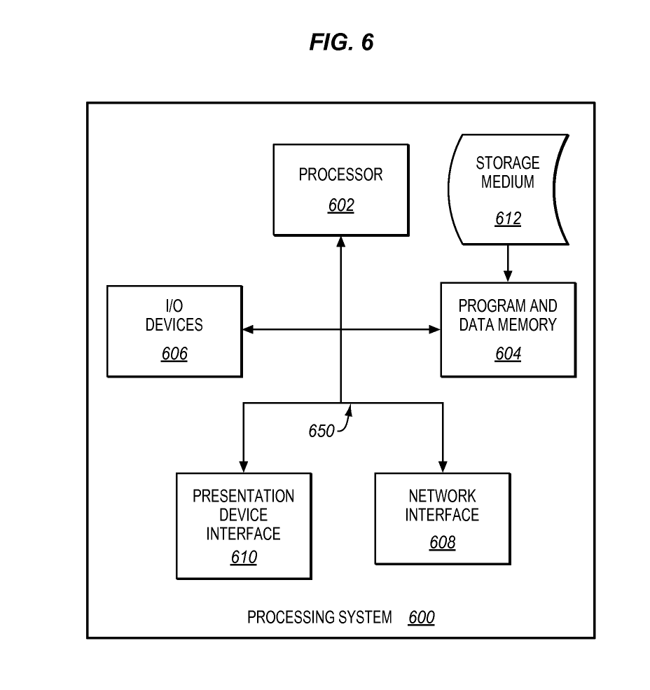

Embodiments disclosed herein can take the form of software, hardware, firmware, or various combinations thereof. FIG. 6 is a block diagram of a processing system configured to execute programmed instructions to perform desired functions in an exemplary embodiment.

Processing system 600 is operable to perform the above operations by executing programmed instructions tangibly embodied on computer readable storage medium 612. In this regard, embodiments of the invention can take the form of a computer program accessible via computer-readable medium 612 providing program code for use by a computer or any other instruction execution system. For the purposes of this description, computer readable storage medium 612 can be anything that can contain or store the program for use by the computer.

Computer readable storage medium 612 can be an electronic, magnetic, optical, electromagnetic, infrared, or semiconductor device. Examples of computer readable storage medium 612 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 600, being suitable for storing and/or executing the program code, includes at least one processor 602 coupled to program and data memory 604 through a system bus 650. Program and data memory 604 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 606 (including but not limited to keyboards, displays, pointing devices, etc.) can be coupled either directly or through intervening I/O controllers. Network adapter interfaces 608 may also be integrated with the system to enable processing system 600 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 610 may be integrated with the system to interface to one or more presentation devices, such as printing systems and displays for presentation of presentation data generated by processor 602.

Although specific embodiments were described herein, the scope of the invention is not limited to those specific embodiments. The scope of the invention is defined by the following claims and any equivalents thereof.

I claim:

1. An apparatus comprising:
a processor of a computing device that is configured to identify a local folder of the computing device, and to identify a batch file in the local folder that defines a plurality of files to upload from the local folder to an online document management system;
the processor configured to parse the batch file to identify a local file in the local folder, to parse the batch file to identify a remote folder at the document management system for storing a remote copy of the local file, and to parse the batch file to identify metadata assigned to the local file;
the processor configured to transmit a first Remote Procedure Call (RPC) request to the document management system to upload the local file to the remote folder, and to transmit a second RPC request to the document management system to assign the metadata to the remote copy of the local file.

2. The apparatus of claim 1 wherein:
the processor, to transmit the first RPC request, is configured to transmit a first Application Programming Interface (API) request to the document management system to upload the local file to the remote folder; and
the processor, to transmit the second RPC request, is configured to transmit a second API request to the document management system to assign the metadata to the remote copy of the local file.

3. The apparatus of claim 2 wherein:
the processor is configured to parse the batch file to identify a rendition file associated with the local file that has a different file format than the local file, and to transmit an API request to the document management system to upload the rendition file to the remote folder.

4. The apparatus of claim 2 wherein:
the processor is configured to archive the local file in an archive folder of the computing device responsive to uploading the local file and assigning the metadata to the remote copy.

5. The apparatus of claim 2 wherein:
the processor is configured to determine that the remote folder does not exist on the document management system, and to transmit an API request to the document management system to create the remote folder.

6. The apparatus of claim 2 wherein:
the metadata comprises a remote name assigned to the remote copy; and
the processor is configured to parse the batch file to identify the remote name, and to transmit an API request to the document management system to assign the remote name to the remote copy.

7. The apparatus of claim 2 wherein:
the metadata comprises permissions for accessing the remote copy by users of the document management system; and
the processor is configured to parse the batch file to identify the permissions, and to transmit an API request to the document management system to assign the permissions to the remote copy.

8. The apparatus of claim 2 wherein:
the metadata comprises a document type for the local file; and
the processor is configured to parse the batch file to identify the document type, and to transmit an API request to the document management system to assign the document type to the remote copy.

9. A method comprising:
identifying a local folder of the computing device;
identifying a batch file in the local folder that defines a plurality of files to upload from the local folder to an online document management system;
parsing the batch file to identify a local file in the local folder;
parsing the batch file to identify a remote folder at the document management system for storing a remote copy of the local file;
parsing the batch file to identify metadata assigned to the local file;
transmitting a first Remote Procedure Call (RPC) request to the document management system to upload the local file to the remote folder; and
transmitting a second RPC request to the document management system to assign the metadata to the remote copy of the local file.

10. The method of claim 9 wherein:
transmitting the first RPC request comprises transmitting an Application Programming Interface (API) request to the document management system to upload the local file to the remote folder; and
transmitting the second RPC request comprises transmitting an API request to the document management system to assign the metadata to the remote copy of the local file.

11. The method of claim 10 comprising:
parsing the batch file to identify a rendition file associated with the local file that has a different file format than the local file; and
transmitting an API request to the document management system to upload the rendition file to the remote folder.

12. The method of claim 10 comprising:
archiving the local file in an archive folder of the computing device responsive to uploading the local file and assigning the metadata to the remote copy.

13. The method of claim 10 comprising:
determining that the remote folder does not exist on the document management system; and
transmitting an API request to the document management system to create the remote folder.

14. The method of claim 10 wherein:
the metadata comprises a remote name assigned to the remote copy; and
the method comprises:
parsing the batch file to identify the remote name; and
transmitting an API request to the document management system to assign the remote name to the remote copy.

15. The method of claim 10 wherein:
the metadata comprises permissions for accessing the remote copy by users of the document management system; and
the method comprises:
parsing the batch file to identify the permissions; and
transmitting an API request to the document management system to assign the permissions to the remote copy.

16. The method of claim 10 wherein:
the metadata comprises a document type for the local file; and
the method comprises:
parsing the batch file to identify the document type; and
transmitting an API request to the document management system to assign the document type to the remote copy.

17. A non-transitory computer readable medium embodying instructions which, when executed by a processor of a computing device, direct the processor to:
identify a local folder of the computing device;
identify a batch file in the local folder that defines a plurality of files to upload from the local folder to an online document management system;
parse the batch file to identify a local file in the local folder;
parse the batch file to identify a remote folder at the document management system for storing a remote copy of the local file;
parse the batch file to identify metadata assigned to the local file;
transmit a first Remote Procedure Call (RPC) request to the document management system to upload the local file to the remote folder; and
transmit a second RPC request to the document management system to assign the metadata to the remote copy of the local file.

18. The non-transitory computer readable medium of claim 17 wherein:
instructions directing the processor to transmit the first RPC request comprise instructions that direct the processor to transmit an Application Programming Interface (API) request to the document management system to upload the local file to the remote folder; and
Instructions directing the processor to transmit the second RPC request comprise instructions that direct the processor to transmit an API request to the document management system to assign the metadata to the remote copy of the local file.

19. The non-transitory computer readable medium of claim 18 wherein the instructions direct the processor to:
process the batch file to identify a rendition file associated with the local file that has a different file format than the local file; and
transmit an API request to the document management system to upload the rendition file to the remote folder.

20. The non-transitory computer readable medium of claim 18 wherein the instructions direct the processor to:
archive the local file in an archive folder of the computing device responsive to uploading the local file and assigning the metadata to the remote copy.
